(19) United States
(12) Patent Application Publication
(10) Pub. No.: US 2024/0296305 A1
(43) Pub. Date: Sep. 5, 2024

(54) PASSIVELY POWERED IOT DEVICES

(71) Applicant: Funai Electric Co., Ltd., Daito-shi, Osaka-fu (JP)

(72) Inventors: Seth Adrian MILLER, Longmont, CO (US); Nery STRASMAN, Ramat Gan (IL); Mordehai MARGALIT, Yaaqov (IL); Dedbmalya BISWAS, Vaud (CH)

(73) Assignee: Funai Electric Co., Ltd., Daito-shi, Osaka-fu (JP)

(21) Appl. No.: 17/908,871

(22) PCT Filed: Dec. 14, 2020
(86) PCT No.: PCT/US2020/064744

§ 371 Date: Sep. 1, 2022

(51) Int. Cl. G06K 19/07; G06K 7/10

(52) U.S. Cl. CPC G06K 19/0709; G06K 7/10158; G06K 7/10475; G06K 19/0724

(57) ABSTRACT

Technologies are generally described for passively powering wireless IoT devices. An actively powered transmitter may transmit a radio frequency (RF) signal over a common channel and information associated with parameters of a reply signal to various passively powered wireless devices. The wireless devices may extract power from the RF signal or other signals in the ambient environment, use the extracted power to perform operations, and backscatter a reply signal over a different channel defined by the RF signal. The reply signal from the passively powered wireless devices may be received by a base station or an actively powered device in the vicinity and forwarded to the base station. Various multiplexing schemes may be employed to prevent collision of reply signals from the passively powered wireless devices.

### BACKGROUND

Unless otherwise indicated herein, the materials described in this section are not prior art to the claims in this application and are not admitted to be prior art by inclusion in this section.

With the proliferation of computing and networking technologies, ever increasing number and decreasing size of various special purpose devices are found commonly around homes, offices, and other locations. For example, Internet of Things (IOT) enabled wireless devices are used to monitor and control a wide variety of aspects of daily life ranging from security to environmental controls. Such devices require power to operate their circuitry and communicate with their respective networks. Even low power devices using batteries have limited operational life. Furthermore, battery replacement from a large number of devices can be detrimental to the environment. On the other hand, providing power through existing or new wiring may be cumbersome and result in restrictions of use and installation of such devices hinders many useful applications.

### SUMMARY

The present disclosure generally describes techniques for passively powering wireless IoT devices.

According to some examples, a system to passively power wireless devices may include a plurality of wireless devices, each wireless device comprising electronic circuitry, a modulator, and an antenna. Each wireless device may be configured to extract operating power from a received radio frequency (RF) signal; perform an operation using the extracted power; and transmit a backscatter signal associated with the performed operation through the antenna. The system may also include a transmitter configured to transmit a common synchronization signal at a first frequency and a communication signal at a second frequency. The first and second frequencies may be distinct, the first frequency may be common for all of the plurality of wireless devices, and the common synchronization signal may identify one or more backscatter parameters. The system may further include one or more receivers to receive the backscatter signal at the second frequency.

According to further examples, an Internet of Things (IOT) device may include a power extraction circuit configured to extract operating power from a received radio frequency (RF) signal; electronic circuitry configured to perform operations using the extracted power; a modulator configured to modulate a backscatter signal associated with the performed operation; and an antenna configured to transmit the backscatter signal, where one or more backscatter parameters for the backscatter signal may be received through a common synchronization signal at a first frequency from an actively powered transmitter, the backscatter signal may be transmitted at a second frequency defined by the one or more backscatter parameters, and the first and second frequencies may be distinct.

According to other examples, a method to passively power wireless devices may include receiving, at a passively power wireless device, a radio frequency (RF) common synchronization signal at a first frequency from an actively powered transmitter; extracting power from the received RF common synchronization signal; performing an operation using the extracted power; and transmitting a backscatter signal associated with the performed operation at a second frequency to be received by one or more actively powered receivers, where the first and second frequencies are distinct, and the RF common synchronization signal identifies one or more backscatter parameters.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 includes an architectural illustration of a home, where Internet of Things (IOT) wireless devices may be used through passive powering;

FIG. 2 includes an illustration of an actively powered transmitters, receivers, and passively powered wireless devices;

FIG. 3 includes illustrations of an example passively powered wireless device in communication with a hub device;

FIG. 4 illustrates major components of an example system for passively powering wireless IoT devices;

FIG. 5 illustrates a computing device, which may be used to passively power wireless IoT devices;

FIG. 6 is a flow diagram illustrating an example method for passively powering wireless IoT devices that may be performed by a computing device such as the computing device in FIG. 5; and

FIG. 7 illustrates a block diagram of an example computer program product, all of which are arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to passively powering wireless IoT devices.

Briefly stated, technologies are generally described for passively powering wireless IoT devices. An actively powered transmitter may transmit a radio frequency (RF) signal over a common channel and information associated with parameters of a reply signal to various passively powered wireless devices. The wireless devices may extract power from the RF signal or other signals in the ambient environment, use the extracted power to perform operations, and backscatter a reply signal over a different channel defined by the RF signal. The reply signal from the passively powered wireless devices may be received by a base station or an actively powered device in the vicinity and forwarded to the base station. Various multiplexing schemes may be employed to prevent collision of reply signals from the passively powered wireless devices.

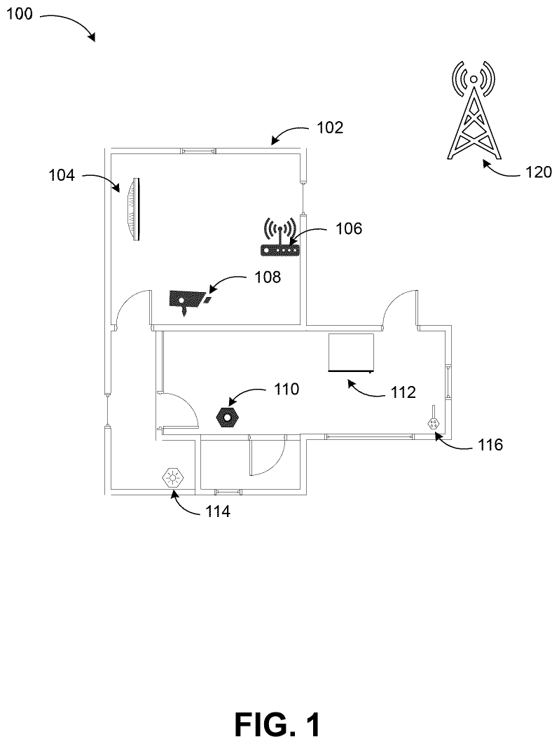

FIG. 1 includes an architectural illustration of a home, where Internet of Things (IT) wireless devices may be used through passive powering, arranged in accordance with at least some embodiments described herein.

Diagram 100 shows a home 102 with a smart television 104, security camera 108, smart refrigerator 112, lighting control 114, motion sensor 110, and temperature controller 116. The home 102 also includes a hub (or customer premises equipment “CPE”) 106, which may communicate wirelessly with base station 120. Smart television 104, security camera 108, smart refrigerator 112, lighting control 114, motion sensor 110, and temperature controller 116 may communicate wirelessly with the base station 120 directly or through the hub 106 and may be configured as IoT devices having their respective IP addresses. The IoT devices may communicate status and other information associated with their respective operations to other devices through wireless communications. They may also receive instructions associated with their respective operations from other devices over the network.

An IoT device is a device that is connected to the Internet and passes data from itself to a secondary processor that is physically distinct. The smart television 104, security camera 108, smart refrigerator 112, lighting control 114, motion sensor 110, and temperature controller 116 are illustrative examples of IoT devices and do not constitute a limit on types of wireless devices according to embodiments. Other examples may include, but are not limited to, control devices for managing a temperature, a humidity, an air flow speed, a lighting level, a lighting composition, a sound level, and/or a sound composition, sensors such as a temperature sensor, a humidity sensor, a sound sensor, a light detection sensor, an air flow sensor, a body sensor, or comparable input devices, for example. Sensors, an example category of IoT devices are configured to detect various environmental characteristics or other physical phenomena such as motion. A sensor may be programmed to issue an alert (a wired or wireless signal) indicating a value above a threshold (e.g., temperature or humidity) has been detected. A sensor may also be programmed to transmit detected/measured values over a time period periodically, randomly, or on demand.

The home 102 in diagram 100 is also an illustrative example for a location, where embodiments may be implemented, but is not intended to limit embodiments. Other locations may include, but are not limited to, an office, a school, a health care facility, a hotel, a factory, or comparable buildings, as well as, a vehicle such as an automobile, a bus, a recreational vehicle, an airplane, a ship, and similar ones.

While some IoT devices may communicate over wired networks such as local area networks (LANs), digital subscriber line (DSL) networks, optical networks, cable networks, others may communicate over wireless networks such as wireless LANs, cellular networks, terrestrial or satellite communication links, and comparable ones, which can provide sufficient bandwidth. Wireless technologies such as 4G, LTE, 5G and any current or future cellular wireless technologies or satellite communication technologies may be used to communicate with IoT devices along with microwave, whole-city Wifi®, and combinations of similar technologies. For example, the common channel (and/or the reply channel may be in 2.5-3.7 GHz band or in the 25-39 GHz band of the 5G protocol.

Fifth generation technology(5G) standard for cellular networks is the most recent network. 5G networks are digital cellular networks, in which the service area is divided into small geographical areas called cells. All 5G wireless devices in a cell exchange digital data with the Internet and the telephone network by radio waves through a local antenna in the cell. 5G networks provide greater bandwidth compared to previous standards allowing higher download speeds more than 10 gigabits per second (Gbit/s). This, in turn, allows cellular service providers to become Internet service providers interconnecting most user devices.

5G protocol replaces a number of the hardware components of the cellular network with software that “virtualizes” the network by using the common language of Internet Protocol (IP). The increased speed/bandwidth is achieved in 5G networks partly by using higher-frequency radio waves than current cellular networks. Low band 5G uses a similar frequency range to current 4G network in the 600-700 MHz range supporting download speeds a little higher than 4G (30-250 megabits per second). Mid band 5G uses microwaves in the range of 2.5-3.7 GHz allowing speeds of 100-900 Mbit/s with each cell tower providing service up to several miles in radius. High band 5G uses frequencies in the range of 25-39 GHz, near the millimeter wave band, although higher frequencies may be used in the future. The high band may achieve download speeds of a gigabit per second, comparable to cable Internet. There are various versions of 5G. Thus, embodiments may be implemented in 5G or 5G-compliant networks, which may have variations in different aspects of the protocol.

As the IoT devices get more complex and smaller, powering them for uninterrupted operation and ease of use is a challenge. Some IoT devices may be powered through wired power network, while others may be battery powered. Such devices are referred to as “actively powered devices” herein. Embodiments include “passively powered devices”, which refers to a wireless IoT device that is capable of extracting power from a received RF signal, use the extracted signal to power its circuitry and perform operations, and communicate with other devices (e.g., actively powered devices) via backscattering. While passively powered wireless devices may mainly use power extracted from received RF signals to operate, they may also include backup batteries or similar power systems.

In some examples, an at-location transmitter (e.g., at the home 102) may transmit the RF signal over a common synchronization channel (common frequency for all passively powered wireless devices). The RF signal may also include backscatter parameters. The IoT devices may extract power from the signal, perform their operations, and backscatter a reply signal over a different frequency identified by the received backscatter parameters. For example, to accommodate a large number of IoT devices attempting to communicate at the same time, different frequencies may be assigned to different IoT devices. Further multiplexing approaches such as CDMA or OFDM may also be employed. The backscatter reply from the individual wireless IoT devices may be received by an at-location receiver such as the hub 106 and forwarded to the base station 120 or, if the signal is strong enough, directly by the base station 120. The reply signal may not necessarily be instantaneous, that is, immediately follow the RF signal. For example, some IoT devices may backscatter at preset intervals. In other examples, the backscatter parameters may define timing of the reply signal(s).

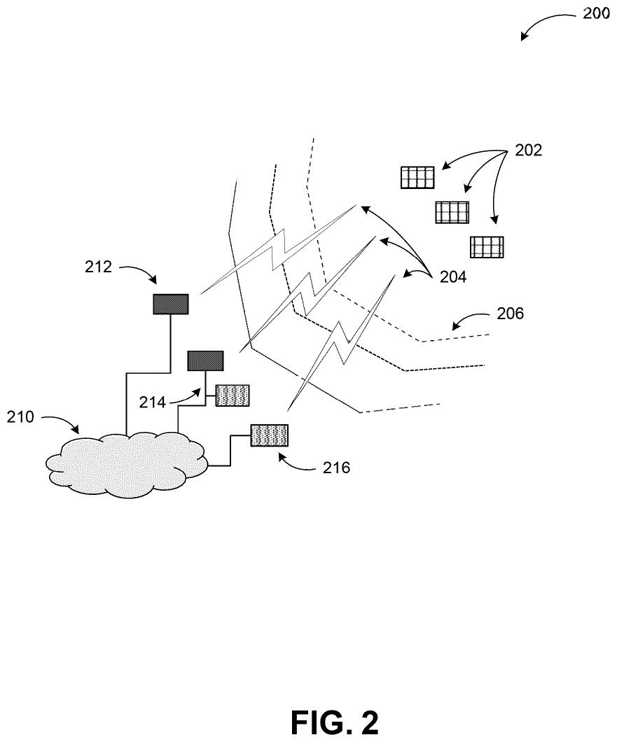

FIG. 2 includes an illustration of an actively powered transmitters, receivers, and passively powered wireless devices, arranged in accordance with at least some embodiments described herein.

Diagram 200 shows multiple passively powered wireless devices 202 receiving RF signals 204 from transmitters and replying via backscattering 206. Different configurations shown in the diagram include a transmitter 212 transmitting the RF common synchronization signal and a separate transmitter 216 receiving the backscatter signal or a combined transmitter and receiver 214 transmitting the RF signal and receiving the backscatter signal. The transmitters and the receivers may be communicatively coupled to other systems and devices via one or more networks such as network 210.

As shown in the diagram a networked actively powered device (212 or 214) may transmit an RF signal at a common frequency to the passively powered wireless devices 202. Passively powered wireless devices 202 may respond by modulation of their antenna impedance and resulting in RF backscatter 206. A frequency of the backscatter may be instructed to the passively powered wireless devices 202 in form of backscatter parameters in the RF signal 204. For example, in a system using a 5G cellular network, the frequencies may be in one of the 5G bands. If the backscatter signal is strong enough and/or a cellular network base station is sufficiently near, the signal may be received directly by the base station. In other examples, the backscatter may be received by a local hub and forwarded to the base station. In yet other examples, actively powered 5G receivers at the location may receive the backscatter signal and relay through the local hub to a base station.

A transmitter transmitting the RF signal and a receiver receiving the backscatter signal may be part of a single actively powered device or part of separate devices. as shown in the diagram. In some examples, the backscatter signal may be received by multiple receivers and relayed to the hub, which may determine duplicate signals and process them accordingly. In other examples, a transmitter may transmit the RF signal, but the backscatter signal may be received at greater strength by a receiver other than one associated with the transmitter. Regardless of the receiver, the backscatter signal may reach the hub and through the hub the network in which it is processed and forwarded to its destination. In some embodiments, the passively powered wireless devices may be initially activated and registered on a respective network.

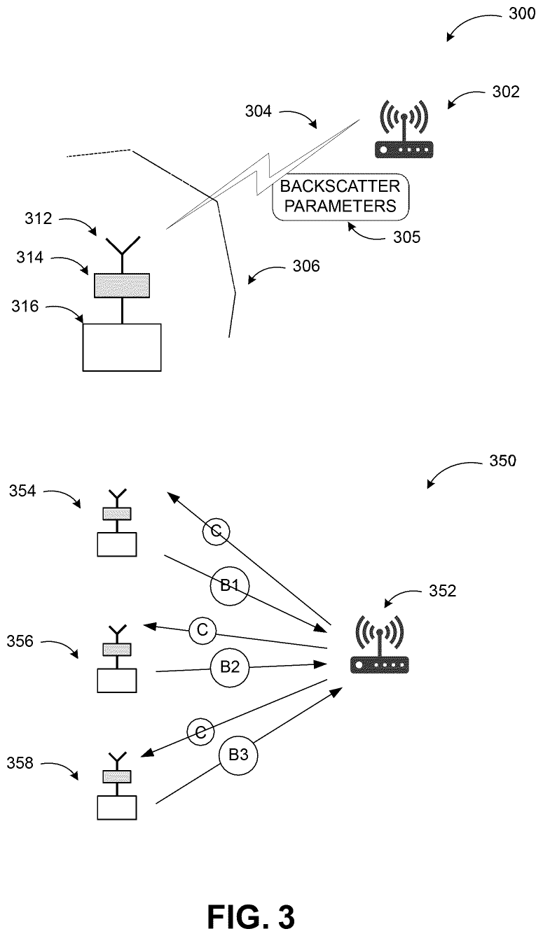

FIG. 3 includes illustrations of an example passively powered wireless device in communication with a hub device, arranged in accordance with at least some embodiments described herein.

Diagram 300 in FIG. 3 shows an example passively powered wireless device and its major components, antenna 312, modulator 314, and circuitry 316. A hub 302 may transmit an RF signal 304 to the passively powered wireless device, which may receive the signal through the antenna 312, extract power to operate the circuitry 316, and reply with a backscatter signal 306 to the hub 302 by modulating an impedance of the antenna 312. RF signal 304 may include backscatter parameters 305, which may provide a receiving device with aspects of their reply such as which frequency to use, when to reply, which multiplexing scheme to use, or even which format to transmit the data in.

Examples of passively powered wireless devices include, but are not limited to, sensors, control units and switches, image sensors, cameras, thermal sensors, thermal cameras, appliances, sensors in appliances or embedded in furniture, appliances, buildings garden, plants or structures. As passively powered wireless devices, these devices do not transmit an RF signal but modulate a received RF signal by modulating the radar cross section (RCS) or impedance of their antenna. As a result, an RF signal traversing the volume of the antenna is modulated and the modulation is a backscatter modulation of information from the passively powered device.

The antenna impedance may be modulated by changing a coupling between antenna and ground. In some examples, the antenna, by need and design, may be a broadband antenna covering the potential bands of the network (e.g., 5G). Thus, any modulation of the antenna may appear as a disturbance in multiple bands. In a scenario, where a large number of passively powered wireless devices are present and multiple devices may be backscattering at the same time, collision prevention measures may be employed.

Antenna 312 is an example of a frequency diversity antenna, where the frequency diversity is obtained by including a frequency selective or tunable filter in the path to ground. For frequencies in the passband of the filter, the antenna may attenuate the RF signal, whereas for other frequencies it may not. In this manner, only the channel in the frequency of the filter may have backscatter modulation. Thus, multiple devices may operate in parallel each with its own backscatter channel. The control channel (common synchronization signal) may assign backscatter channels to each IoT device to enhance the capacity of communication in a given area. Examples of tunable filters include, but are not limited to, tunable varactors using electronic or MEMS technology, switchable capacitor banks, tunable delay lines, and similar ones. Filter implementations with low power requirements may be selected as available power (extracted from the received RF signal) may be limited.

Diagram 350 of FIG. 3 shows an example configuration, where multiple communication channels for respective passively powered wireless devices are used to avoid collision. Hub 352 may transmit a common synchronization signal at a first frequency (C) that is common for all wireless devices 354, 356, 358. Individual wireless devices 354, 356, and 358 may respond with a backscatter on respective frequencies B1, B2, and B3 based on instructions included in the common synchronization signal. Hence, at least two channels are used to communicate with the IoT devices. A first channel to control the backscatter parameters and a second as the channel on which the backscatter modulation occurs. The control channel further provides synchronization among transmitted data from the IoT devices and a receiver.

5G protocol may provide a suitable RF platform as the frequency diversity is easier to achieve at higher frequencies and especially above 5 GHz. In an alternative example, the backscatter diversity may be achieved by a modulation code. Examples of modulation code include Code Division Multiple Access (CDMA) or Orthogonal Frequency-Division Multiplexing (OFDM). All IoT devices may backscatter on a channel or channels. In one example each device may encode the transmitted information with a unique orthogonal code. In an alternative approach, the transmitter may transmit an RF signal with a code modulation. The IoT device may be synchronized to the code signal and the backscatter further encoded with a corresponding code. The result is a code diversity scheme in both transmit and backscatter signals. The code diversity scheme is used to improve reliability of a message signal by using two or more communication channels with different characteristics, thereby, reducing harmful effects of interference or fading. A receiver with the code may detect the transmitted information even in the presence of other device transmissions, as well as noise. For power efficient detection, synchronization between transmitter and receiver may be needed. In one example, synchronization may be obtained through the RF backscatter channel or through the control channel, which provides both code distribution as well as synchronization signal.

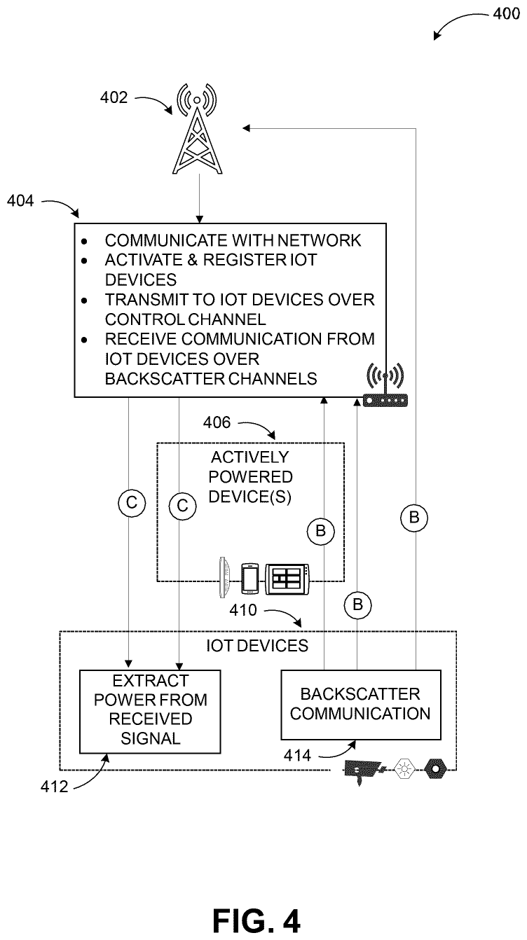

FIG. 4 illustrates major components of an example system for passively powering wireless IoT devices, arranged in accordance with at least some embodiments described herein.

Diagram 400 shows major actions by different components of a system according to embodiments. For example, a hub 404 in wireless communication with a network base station 402 may communicate with the network, activate and register IoT devices, transmit RF signal to the IoT devices over a control channel, and receive communication from the IoT devices over one or more backscatter channels. IoT devices 410 may each be capable of extracting power from the received RF signal to operate (412) and backscatter their communication (414) over the backscatter channel(s). The IoT devices 410 may receive the RF signal (C) directly from the hub 404 or from the transmitter of an actively powered device 406, which may communicate with the hub 404. The backscatter signal (B) may be received from the IoT devices 410 by the hub 404, by the actively powered device 406, or directly by the base station 402.

The passively powered IoT devices 410 may include sensors, controllers, appliances, and other devices as discussed herein. The actively powered device(s) 406 may include, but are not limited to, environmental control devices, a desktop computer, a handheld computer, a smart phone, a smartwatch, a vehicle-mount computer, or similar ones. As discussed above, various collision prevention schemes may be employed to manage a large number of IoT devices at a given location. The hub 404, the base station 402, or a control device (e.g., a server) at the network may employ machine learning algorithms to manage the communications with the various IoT devices.

Artificial Intelligence (AI) algorithms control any device that perceives its environment and takes actions that maximize its chance of successfully achieving predefined goals such as optimizing reception of backscatter signals from various IoT devices, etc. A subset of AI, machine learning (ML) algorithms build a mathematical model based on sample data (training data) in order to make predictions or decisions without being explicitly programmed to do so. In some examples, an AI planning algorithm or a specific ML algorithm may be employed to determine communication settings. For example, locations of some IoT devices may change over time or other obstructions may affect backscatter signal strength. Thus, a same receiver may not be relied upon to receive backscatter signal from the same IoT devices all the time. Employing AI or ML algorithms, the system may determine/predict backscatter signal strengths at various locations (e.g., available actively powered devices or hubs) and select receivers to be used for receiving backscatter signal from particular IoT devices. The ML algorithm may facilitate both supervised and unsupervised learning.

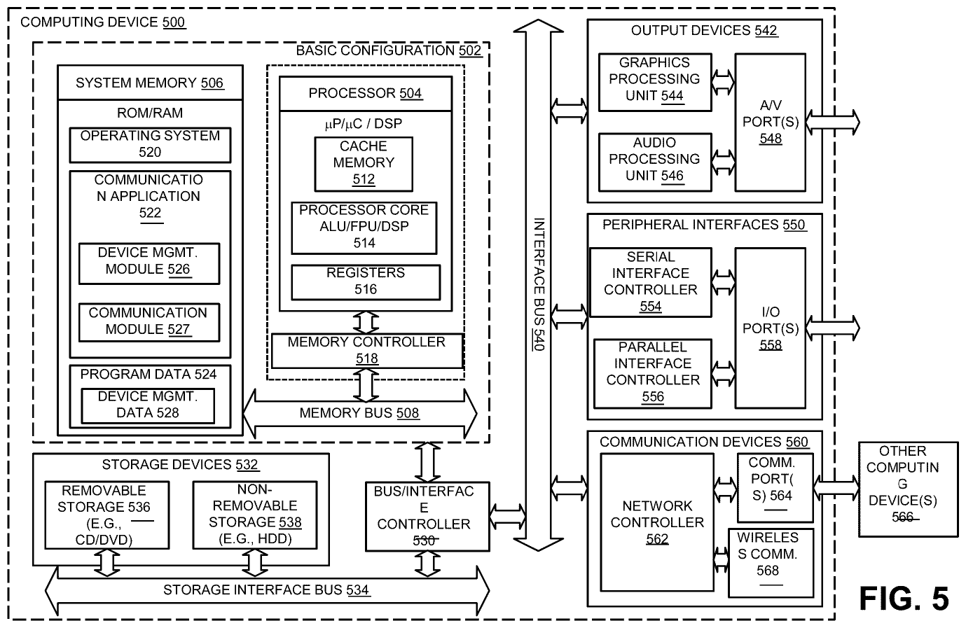

FIG. 5 illustrates a computing device, which may be used to passively power wireless IoT devices, arranged in accordance with at least some embodiments described herein.

In an example basic configuration 502, the computing device 500 may include one or more processors 504 and a system memory 506. A memory bus 508 may be used to communicate between the processor 504 and the system memory 506. The basic configuration 502 is illustrated in FIG. 5 by those components within the inner dashed line.

Depending on the desired configuration, the processor 504 may be of any type, including but not limited to a microprocessor (μP), a microcontroller (μC), a digital signal processor (DSP), or any combination thereof. The processor 504 may include one or more levels of caching, such as a cache memory 512, a processor core 514, and registers 516. The example processor core 514 may include an arithmetic logic unit (ALU), a floating point unit (FPU), a digital signal processing core (DSP core), or any combination thereof. An example memory controller 518 may also be used with the processor 504, or in some implementations, the memory controller 518 may be an internal part of the processor 504.

Depending on the desired configuration, the system memory 506 may be of any type including but not limited to volatile memory (such as RAM), non-volatile memory (such as ROM, flash memory, etc.) or any combination thereof. The system memory 506 may include an operating system 520, a communication application 522, and program data 524. The communication application 522 may include a device management module 526 and a communication module 527. The communication application 522 may transmit an RF signal over a common frequency to various wireless devices. The control application 522 may also transmit information associated with backscatter parameters such that the wireless devices can extract power from the RF signal, operate using the power, and transmit a backscatter reply using the parameters (e.g., frequency). The program data 524 may include device management data 528 such as frequencies to be assigned, modulation types, etc., among other data, as described herein.

The computing device 500 may have additional features or functionality, and additional interfaces to facilitate communications between the basic configuration 502 and any desired devices and interfaces. For example, a bus/interface controller 530 may be used to facilitate communications between the basic configuration 502 and one or more data storage devices 532 via a storage interface bus 534. The data storage devices 532 may be one or more removable storage devices 536, one or more non-removable storage devices 538, or a combination thereof. Examples of the removable storage and the non-removable storage devices include magnetic disk devices such as flexible disk drives and hard-disk drives (HDDs), optical disk drives such as compact disc (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

The system memory 506, the removable storage dev 536 and the non-removable storage devices 538 are examples of computer storage media. Computer storage media includes, but is not limited to, RAM, ROM, EEPROM, flash memory or other memory technology, CD-ROM, digital versatile disks (DVDs), solid state drives (SSDs), or other optical storage, magnetic cassettes, magnetic tape, magnetic disk storage or other magnetic storage devices, or any other medium which may be used to store the desired information and which may be accessed by the computing device 500. Any such computer storage media may be part of the computing device 500.

The computing device 500 may also include an interface bus 540 for facilitating communication from various interface devices (e.g., one or more output devices 542, one or more peripheral interfaces 550, and one or more communication devices 560) to the basic configuration 502 via the bus/interface controller 530. Some of the example output devices 542 include a graphics processing unit 544 and an audio processing unit 546, which may be configured to communicate to various external devices such as a display or speakers via one or more A/V ports 548. One or more example peripheral interfaces 550 may include a serial interface controller 554 or a parallel interface controller 556, which may be configured to communicate with external devices such as input devices (e.g., keyboard, mouse, pen, voice input device, touch input device, etc.) or other peripheral devices (e.g., printer, scanner, etc.) via one or more I/O ports 558. An example communication device 560 includes a network controller 562, which may be arranged to facilitate communications with one or more other computing devices 566 over a network communication link via one or more communication ports 564. The one or more other computing devices 566 may include servers at a datacenter, customer equipment, and comparable devices. The network controller 562 may also control operations of a wireless communication module 568, which may facilitate communication with other devices via a variety of protocols using a number of frequency bands such as WiFi®, cellular (e.g., 4G, 5G), satellite link, terrestrial link, etc.

The network communication link may be one example of a communication media. Communication media may be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include non-transitory storage media.

The computing device 500 may be implemented as a part of a specialized server, mainframe, or similar computer that includes any of the above functions. The computing device 500 may also be implemented as a personal computer including both laptop computer and non-laptop computer configurations.

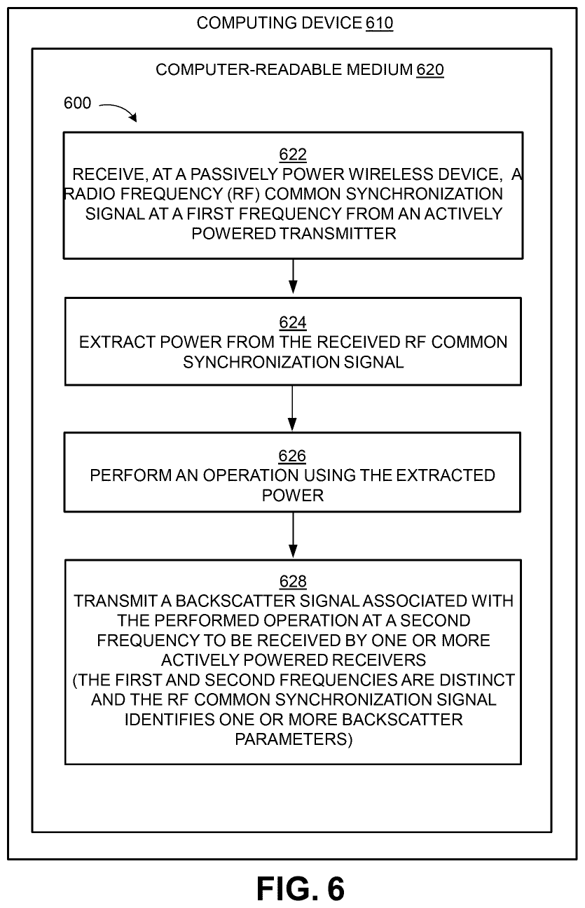

FIG. 6 is a flow diagram illustrating an example method for passively powering wireless IoT devices that may be performed by a computing device such as the computing device in FIG. 5, arranged in accordance with at least some embodiments described herein.

Example methods may include one or more operations, functions, or actions as illustrated by one or more of blocks 622, 624, 626, and 628 may in some embodiments be performed by a computing device such as the computing device 600 in FIG. 6. Such operations, functions, or actions in FIG. 6 and in the other figures, in some embodiments, may be combined, eliminated, modified, and/or supplemented with other operations, functions or actions, and need not necessarily be performed in the exact sequence as shown. The operations described in the blocks 622-628 may be implemented through execution of computer-executable instructions stored in a computer-readable medium such as a computer-readable medium 620 of a computing device 610.

An example process to power passively powered devices may begin with block 622, “RECEIVE, AT A PASSIVELY POWER WIRELESS DEVICE, A RADIO FREQUENCY (RF) COMMON SYNCHRONIZATION SIGNAL AT A FIRST FREQUENCY FROM AN ACTIVELY POWERED TRANSMITTER”, where a passively powered wireless device 410 may receive an RF signal at a first frequency and carrying information associated with backscatter parameters.

Block 622 may be followed by block 624, “EXTRACT POWER FROM THE RECEIVED RF COMMON SYNCHRONIZATION SIGNAL”, where a power extraction circuit (e.g., a rectifier) of the wireless device may extract power from the received RF signal.

Block 624 may be followed by block 626, “PERFORM AN OPERATION USING THE EXTRACTED POWER”, where circuitry of the wireless device may perform an operation using the extracted power. For example, the wireless device may be a monitoring device and record a monitored aspect (e.g., temperature, humidity, image capture, audio capture, etc.). The wireless device may also be a control device and perform a control operation (e.g., setting a mechanical or other system to a specific state).

Block 626 may be followed by block 628, “TRANSMIT A BACKSCATTER SIGNAL ASSOCIATED WITH THE PERFORMED OPERATION AT A SECOND FREQUENCY TO BE RECEIVED BY ONE OR MORE ACTIVELY POWERED RECEIVERS (THE FIRST AND SECOND FREQUENCIES ARE DISTINCT AND THE RF COMMON SYNCHRONIZATION SIGNAL IDENTIFIES ONE OR MORE BACKSCATTER PARAMETERS)”, where the wireless device may transmit a backscatter reply signal over a second frequency identified by the backscatter parameters. The reply may include information associated with the performed operation. The first and second frequencies may be distinct, where the first frequency is a common frequency for all wireless devices at the location and the second frequency is specific to each wireless device.

The operations included in process 600 are for illustration purposes. Powering passively powered wireless devices may be implemented by similar processes with fewer or additional operations, as well as in different order of operations using the principles described herein. The operations described herein may be executed by one or more processors operated on one or more computing devices, one or more processor cores, and/or specialized processing devices, among other examples. In further examples, parallel processing may be employed, computations or the execution of processes may be carried out simultaneously by one or more processors dividing large tasks into smaller ones and solving at the same time. Tasks split for parallel processing may be controlled by necessary elements. Different types of parallel processing such as bit-level, instruction-level, data, and task parallelism may be used.

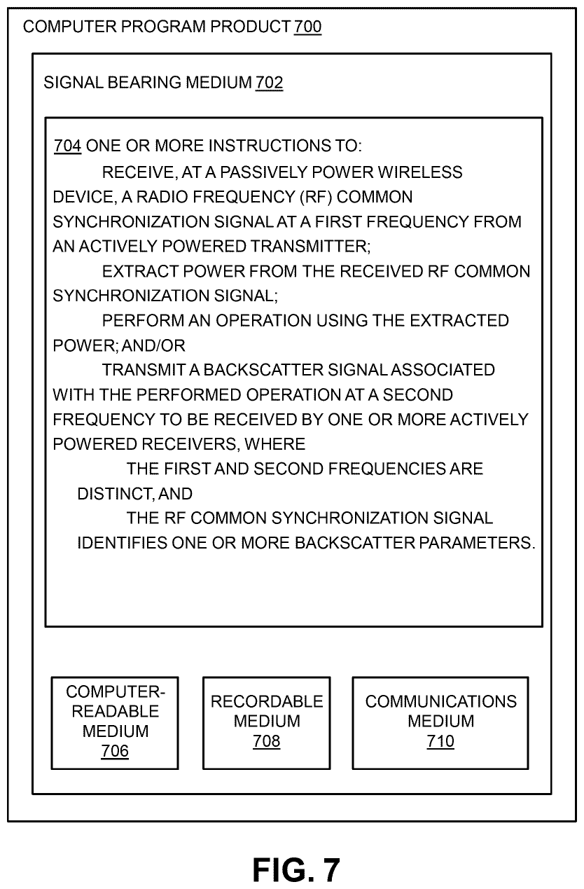

FIG. 7 illustrates a block diagram of an example computer program product, arranged in accordance with at least some embodiments described herein.

In some examples, as shown in FIG. 7, a computer program product 700 may include a signal bearing medium 702 that may also include one or more machine readable instructions 704 that, in response to execution by, for example, a processor may provide the functionality described herein. Thus, for example, referring to the processor 504 in FIG. 5, the communication application 522 may perform or control performance of one or more of the tasks shown in FIG. 7 in response to the instructions 704 conveyed to the processor 504 by the signal bearing medium 702 to perform actions associated with powering passively powered wireless devices as described herein. Some of those instructions may include, for example, receive, at a passively power wireless device, a radio frequency (RF) common synchronization signal at a first frequency from an actively powered transmitter; extract power from the received RF common synchronization signal; perform an operation using the extracted power; and/or transmit a backscatter signal associated with the performed operation at a second frequency to be received by one or more actively powered receivers (the first and second frequencies are distinct and the RF common synchronization signal identifies one or more backscatter parameters), according to some embodiments described herein.

In some implementations, the signal bearing medium 702 depicted in FIG. 7 may encompass computer-readable medium 706, such as, but not limited to, a hard disk drive (HDD), a solid state drive (SSD), a compact disc (CD), a digital versatile disk (DVD), a digital tape, memory, and comparable non-transitory computer-readable storage media. In some implementations, the signal bearing medium 702 may encompass recordable medium 708, such as, but not limited to, memory, read/write (R/W) CDs, R/W DVDs, etc. In some implementations, the signal bearing medium 702 may encompass communications medium 710, such as, but not limited to, a digital and/or an analog communication medium (e.g., a fiber optic cable, a waveguide, a wired communication link, a wireless communication link, etc.). Thus, for example, the computer program product 700 may be conveyed to one or more modules of the processor 504 by an RF signal bearing medium, where the signal bearing medium 702 is conveyed by the communications medium 710 (e.g., a wireless communications medium conforming with the IEEE 802.11 standard or 5G protocol).

According to some examples, a system to passively power wireless devices may include a plurality of wireless devices, each wireless device comprising electronic circuitry, a modulator, and an antenna. Each wireless device may be configured to extract operating power from a received radio frequency (RF) signal; perform an operation using the extracted power; and transmit a backscatter signal associated with the performed operation through the antenna. The system may also include a transmitter configured to transmit a common synchronization signal at a first frequency and a communication signal at a second frequency. The first and second frequencies may be distinct, the first frequency may be common for all of the plurality of wireless devices, and the common synchronization signal may identify one or more backscatter parameters. The system may further include one or more receivers to receive the backscatter signal at the second frequency.

According to other examples, the plurality of wireless devices may be Internet of Things (IOT) devices. The one or more receivers may include an at-location hub device, an actively powered IoT device, or a base station. The at-location hub device and the actively powered IoT device may be configured to forward the received backscatter signal to a base station. The plurality of wireless devices may be configured to transmit the backscatter signal in one of a wireless local area network (WLAN) frequency band or a cellular frequency band. The plurality of wireless devices may be configured to transmit the backscatter signal in a cellular frequency band according to a 5G-compliant protocol. The one or more backscatter parameters may define the second frequency, a modulation format, or a modulation code. The modulation code may include a frequency in a frequency diversity scheme, a code in a Code Division Multiple Access (CDMA) modulation scheme, or a code in an Orthogonal Frequency-Division Multiplexing (OFDM) modulation scheme. The transmitter may be configured to assign one or more different values for the second frequency when two or more wireless devices backscatter to the one or more receivers in a temporally overlapping manner. The transmitter and at least one of the one or more receivers may be part of a single device.

According to further examples, an Internet of Things (IOT) device may include a power extraction circuit configured to extract operating power from a received radio frequency (RF) signal; electronic circuitry configured to perform operations using the extracted power; a modulator configured to modulate a backscatter signal associated with the performed operation; and an antenna configured to transmit the backscatter signal, where one or more backscatter parameters for the backscatter signal may be received through a common synchronization signal at a first frequency from an actively powered transmitter, the backscatter signal may be transmitted at a second frequency defined by the one or more backscatter parameters, and the first and second frequencies may be distinct.

According to some examples, one or both of the first frequency and the second frequency may be in a wireless local area network (WLAN) frequency band or a cellular frequency band. The second frequency may be in a cellular frequency band according to 5G protocol. The one or more backscatter parameters may define the second frequency, a modulation format, or a modulation code. The modulation code may include a frequency in a frequency diversity scheme, a code in a Code Division Multiple Access (CDMA) modulation scheme, or a code in an Orthogonal Frequency-Division Multiplexing (OFDM) modulation scheme.

According to other examples, a method to passively power wireless devices may include receiving, at a passively power wireless device, a radio frequency (RF) common synchronization signal at a first frequency from an actively powered transmitter; extracting power from the received RF common synchronization signal; performing an operation using the extracted power; and transmitting a backscatter signal associated with the performed operation at a second frequency to be received by one or more actively powered receivers, where the first and second frequencies are distinct, and the RF common synchronization signal identifies one or more backscatter parameters.

According to further examples, the wireless device may be an Internet of Things (IoT) device and the one or more receivers may include an at-location hub device, an actively powered IoT device, or a base station. Transmitting the backscatter signal associated with the performed operation may include transmitting the backscatter signal in one of a wireless local area network (WLAN) frequency band or a cellular frequency band. Transmitting the backscatter signal associated with the performed operation may include transmitting the backscatter signal in a cellular frequency band according to a 5G-compliant protocol. Transmitting the backscatter signal associated with the performed operation may include transmitting the backscatter signal according to the one or more backscatter parameters that define the second frequency, a modulation format, or a modulation code. The modulation code may include a frequency in a frequency diversity scheme, a code in a Code Division Multiple Access (CDMA) modulation scheme, or a code in an Orthogonal Frequency-Division Multiplexing (OFDM) modulation scheme.

There are various vehicles by which processes and/or systems and/or other technologies described herein may be affected (e.g., hardware, software, and/or firmware), and the preferred vehicle will vary with the context in which the processes and/or systems and/or other technologies are deployed. For example, if an implementer determines that speed and accuracy are paramount, the implementer may opt for mainly hardware and/or firmware vehicle; if flexibility is paramount, the implementer may opt for mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via application specific integrated circuits (ASICs), field programmable gate arrays (FPGAs), digital signal processors (DSPs), or other integrated formats. However, t some aspects of the embodiments disclosed herein, in whole or in part, may be equivalently implemented in integrated circuits, as one or more computer programs executing on one or more computers (e.g., as one or more programs executing on one or more computer systems), as one or more programs executing on one or more processors (e.g., as one or more programs executing on one or more microprocessors), as firmware, or as virtually any combination thereof, and that designing the circuitry and/or writing the code for the software and/or firmware are possible in light of this disclosure.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. The terminology used herein is for the purpose of describing particular embodiments only and is not intended to be limiting.

In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive (HDD), a compact disc (CD), a digital versatile disk (DVD), a digital tape, a computer memory, a solid state drive (SSD), etc.; and a transmission type medium such as a digital and/or an analog communication medium (e.g., a fiber optic cable, a waveguide, a wired communication link, a wireless communication link, etc.).

It is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. A data processing system may include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors.

A data processing system may be implemented utilizing any suitable commercially available components, such as those found in data computing/communication and/or network computing/communication systems. The herein described subject matter sometimes illustrates different components contained within, or connected with, different other components. Such depicted architectures are merely exemplary, and in fact, many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

For any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments are possible. The various aspects and embodiments disclosed herein are for purposes of illustration and are not intended to be limiting, with the true scope and spirit being indicated by the following claims.

1-22. (canceled)

23. A system to passively power wireless devices, the system comprising:
a plurality of wireless devices, each wireless device comprising electronic circuitry, a modulator, and an antenna, wherein each wireless device is configured to:
extract operating power from a received radio frequency (RF) signal;
perform an operation using the extracted operating power; and
transmit a backscatter signal associated with the performed operation through the antenna;
a transmitter configured to transmit a common synchronization signal at a first frequency and a communication signal at a second frequency, wherein
the first and second frequencies are distinct,
the first frequency is common for all of the plurality of wireless devices, and
the common synchronization signal identifies one or more backscatter parameters; and
one or more receivers to receive the backscatter signal at the second frequency.

24. The system of claim 23, wherein the plurality of wireless devices are Internet of Things (IOT) devices.

25. The system of claim 24, wherein the one or more receivers include an at-location hub device, an actively powered IoT device, or a base station.

26. The system of claim 25, wherein the at-location hub device and the actively powered IoT device are configured to forward the received backscatter signal to the base station.

27. The system of claim 23, wherein the plurality of wireless devices are configured to transmit the backscatter signal in one of a wireless local area network (WLAN) frequency band or a cellular frequency band.

28. The system of claim 23, wherein the plurality of wireless devices are configured to transmit the backscatter signal in a cellular frequency band according to a 5G-compliant protocol.

29. The system of claim 23, wherein the one or more backscatter parameters define the second frequency, a modulation format, or a modulation code and wherein the modulation code includes a frequency in a frequency diversity scheme, a code in a Code Division Multiple Access (CDMA) modulation scheme, or a code in an Orthogonal Frequency-Division Multiplexing (OFDM) modulation scheme.

30. The system of claim 23, wherein the transmitter is configured to assign one or more different values for the second frequency when two or more wireless devices backscatter to the one or more receivers in a temporally overlapping manner.

31. The system of claim 23, wherein the transmitter and at least one of the one or more receivers are part of a single device.

32. An Internet of Things (IOT) device comprising:
a power extraction circuit configured to extract operating power from a received radio frequency (RF) signal;
electronic circuitry configured to perform operations using the extracted operating power;
a modulator configured to modulate a backscatter signal associated with the performed operation; and
an antenna configured to transmit the backscatter signal, wherein
one or more backscatter parameters for the backscatter signal are received through a common synchronization signal at a first frequency from an actively powered transmitter,
the backscatter signal is transmitted at a second frequency defined by the one or more backscatter parameters, and
the first and second frequencies are distinct.

33. The IoT device of claim 32, wherein one or both of the first frequency and the second frequency are in a wireless local area network (WLAN) frequency band or a cellular frequency band.

34. The IoT device of claim 32, wherein the second frequency is in a cellular frequency band according to 5G protocol.

35. The IoT device of claim 32, wherein the one or more backscatter parameters define the second frequency, a modulation format, or a modulation code and wherein the modulation code includes a frequency in a frequency diversity scheme, a code in a Code Division Multiple Access (CDMA) modulation scheme, or a code in an Orthogonal Frequency-Division Multiplexing (OFDM) modulation scheme.

36. A method to passively power wireless devices, the method comprising:
receiving, at a passively powered wireless device, a radio frequency (RF) common synchronization signal at a first frequency from an actively powered transmitter;
extracting power from the received RF common synchronization signal;
performing an operation using the extracted power; and
transmitting a backscatter signal associated with the performed operation at a second frequency to be received by one or more actively powered receivers, wherein
the first and second frequencies are distinct, and
the RF common synchronization signal identifies one or more backscatter parameters.

37. The method of claim 36, wherein the wireless device is an Internet of Things (IOT) device and the one or more receivers include an at-location hub device, an actively powered IoT device, or a base station.

38. The method of claim 36, wherein transmitting the backscatter signal associated with the performed operation comprises transmitting the backscatter signal in one of a wireless local area network (WLAN) frequency band or a cellular frequency band.

39. The method of claim 36, wherein transmitting the backscatter signal associated with the performed operation comprises transmitting the backscatter signal in a cellular frequency band according to a 5G-compliant protocol.

40. The method of claim 36, wherein transmitting the backscatter signal associated with the performed operation comprises transmitting the backscatter signal according to the one or more backscatter parameters that define the second frequency, a modulation format, or a modulation code.

41. The method of claim 40, wherein the modulation code includes a frequency in a frequency diversity scheme, a code in a Code Division Multiple Access (CDMA) modulation scheme, or a code in an Orthogonal Frequency-Division Multiplexing (OFDM) modulation scheme.

42. The method of claim 36, further comprising:
determining or predicting backscatter signal strengths at one or more locations; and
selecting one or more receivers to be used for receiving backscatter signal from particular IoT devices based on the determination or prediction.
